(19) United States
(12) Patent Application Publication
(10) Pub. No.: US 2011/0071712 A1
(43) Pub. Date: Mar. 24, 2011

(54) Driving power control apparatus for vehicle and method for controlling vehicle

(75) Inventors: Yuusuke Mizuno, Anjo-city (JP); Kazunao Yamada, Toyota-city (JP); Tadashi Sakai, Obu-city (JP)

(73) Assignee: DENSON CORPORATION, Kariya-city (JP)

(21) Appl. No.: 12/805,487

(22) Filed: Aug. 3, 2010

(30) Foreign Application Priority Data
Sep. 18, 2009 (JP) 2009-217440

(51) Int. Cl. G06F 19/00

(52) U.S. Cl. 701/22; 180/65.275

(57) ABSTRACT

A driving power control apparatus for a vehicle having an internal combustion engine and an electric motor includes a charge specifying unit and a schedule specifying unit. When determining that congestion exists ahead based on received wireless information, the charge specifying unit specifies a required charge quantity of a battery, which is needed at a congestion start, such that a charge quantity of the battery remains more than a predetermined quantity at a congestion end after traveling through the congestion using the motor. The schedule specifying unit extracts a partial section in advance of the congestion start. The schedule specifying unit further specifies a schedule of a control index in the partial section, such that the charge quantity of the battery at the congestion start is more than the required charge quantity.

### CROSS REFERENCE TO RELATED APPLICATIONS

This application is based on and incorporates herein by reference Japanese Patent Application No. 2009-217440 filed on Sep. 18, 2009.

### FIELD OF THE INVENTION

The present invention relates to a driving power control apparatus for controlling driving power of an internal combustion engine and an electric motor of a vehicle. The present invention further relates to a method for controlling a vehicle having an internal combustion engine and an electric motor.

### BACKGROUND OF THE INVENTION

For example, Publication of Unexamined Patent Application 2000-333305 (JP-A-2000-333305) discloses a driving power control apparatus for a hybrid vehicle. The driving power control apparatus forms a charge and discharge schedule in a path from a start point to a destination. Thus, the driving power control apparatus performs a driving power control of an internal combustion engine and an electric motor of the hybrid vehicle according to the charge and discharge schedule. Specifically, the driving power control apparatus causes the motor to travel the vehicle through a section such as a traffic congestion section in which an operation efficiency of the engine is low. In addition, the driving power control apparatus causes the engine to generate electricity in such a traveling section in which engine is used to travel the vehicle and causes the battery to accumulate the generated electricity, which is to be consumed by the motor. It is noted that the driving power control apparatus disclosed in JP-A-2000-333305 requires a user to operate the driving power control apparatus for a route searching to specify a path to a destination. In addition, the driving power control apparatus disclosed in JP-A-2000-333305 forms the charge and discharge schedule with respect to the entire path from the start point to the destination. It is noted that, it may be impossible to perform a driving power control in an actual traveling along with the beforehand formed charge and discharge schedule, due to influence of a driver's operation characteristic, a traffic condition, and the like. If many irregular conditions occur in the driving power control when the driving power control is performed along with the charge and discharge schedule, energy consumption may be rather increased compared with an operation without such a charge and discharge schedule.

### SUMMARY OF THE INVENTION

In view of the foregoing and other problems, it is an object of the present invention to produce a driving power control apparatus for controlling driving power of an internal combustion engine and an electric motor of a vehicle, the driving power control apparatus capable of reducing energy consumption without requiring an operation for specifying a path to a destination. It is another object of the present invention to produce a method for controlling a vehicle having an internal combustion engine and an electric motor.

According to one aspect of the present invention, a driving power control apparatus for controlling a driving power of an internal combustion engine and an electric motor of a vehicle according to a schedule of a specified control index, the driving power control apparatus comprises a receiving unit configured to receive wireless information. The driving power control apparatus further comprises a required charge specifying unit configured to, when determining that a congestion exists ahead based on the wireless information received by the receiving unit, specify a required charge quantity of a battery needed at a congestion start for driving the motor, such that a charge quantity of the battery remains more than a predetermined quantity at a congestion end after traveling through the congestion using the motor. The driving power control apparatus further comprises a schedule specifying unit configured to: extract a partial section in advance of the congestion start; and specify a schedule of a control index in the partial section, such that the charge quantity of the battery at the congestion start is more than the required charge quantity.

According to another aspect of the present invention, a method for controlling a vehicle having an internal combustion engine and an electric motor, the method comprises receiving wireless information. The method further comprises determining whether a congestion exists ahead based on the received wireless information. The method further comprises specifying, when it is determined that a congestion exists ahead, a required charge quantity of a battery needed at a congestion start for driving the motor, such that a charge quantity of the battery remains more than a predetermined quantity at a congestion end after traveling through the congestion using the motor. The method further comprises extracting a partial section in advance of the congestion start. The method further comprises specifying a schedule of a control index in the extracted partial section, such that the charge quantity of the battery at the congestion start is more than the required charge quantity. The method further comprises manipulating a driving power of the internal combustion engine and the electric motor according to the specified schedule of the control index.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a structure of a driving power control apparatus for a hybrid vehicle, according to a first embodiment;

FIG. 2 is a block diagram showing a structure of a navigation ECU of the driving power control apparatus;

FIG. 3 is a flow chart showing a traveling condition storing operation;

FIG. 4 is a view showing one example of a traveling condition stored in a durable storage medium;

FIG. 5 is a flow chart showing a control target value control operation;

FIG. 6 is a flow chart showing a schedule effect determining operation;

FIG. 7 is a view showing one example of extraction of a scheduled section;

FIG. 8 is a flow chart showing a scheduling operation;

FIG. 9 is a graph showing one example of expectation of transition of a target SOC;

FIG. 10 is a flow chart showing a schedule control operation;

FIG. 11 shows one example of a SOC control schedule corresponding to the scheduled section shown in FIG. 7;

FIG. 12 is a flow chart showing a traffic congestion section power consumption specifying operation;

FIG. 13 is a flow chart showing a traffic congestion section determining operation;

FIG. 14 is an explanatory view for explaining retrieval of a traveling history such as a vehicle speed and a driving force;

FIG. 15 is an explanatory view for explaining a traveling history such as a vehicle speed and a driving force stored in the first storage area;

FIG. 16 is an explanatory view for explaining a traveling history such as a vehicle speed and a driving force stored in the third storage area;

FIG. 17 is an explanatory view for explaining a traveling history such as a vehicle speed and a driving force stored in the second storage area; and

FIG. 18 is an explanatory view for explaining a traveling history such as a vehicle speed and a driving force to be stored in the first storage area.

### DETAILED DESCRIPTION OF PREFERRED EMBODIMENTS

### First Embodiment

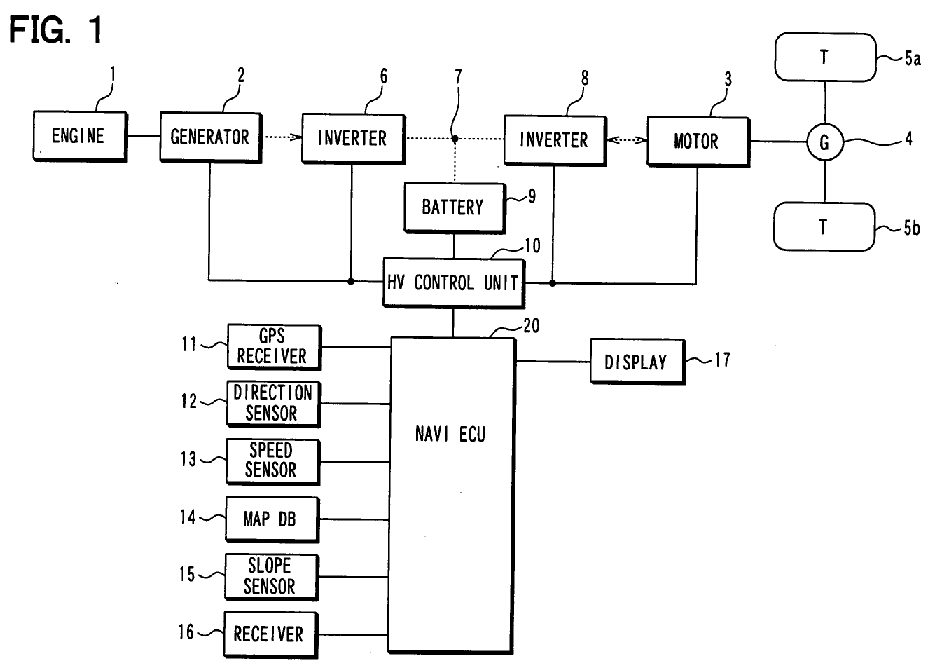

FIG. 1 is an overview showing a vehicle including a vehicle driving power control apparatus related to the first embodiment. The vehicle driving power control apparatus according to the present embodiment is mounted in a hybrid vehicle using an engine and an electric motor as a traveling power source. The vehicle driving power control apparatus is configured to control a driving power of an engine and a motor. The hybrid vehicle includes an internal combustion engine 1, a generator 2, a motor 3, a differential gear 4, tires 5a and 5b, an inverter 6, a DC link 7, an inverter 8, a battery 9, an HV control unit 10, a GPS receiver 11, a direction sensor 12, a vehicle speed sensor 13, a map DB storage unit 14, a slope sensor 15, a wireless receiver 16, a display unit 17, and a navigation ECU 20.

The hybrid vehicle uses the engine 1 and the motor 3 as a power source for traveling. The hybrid vehicle switches multiple driving modes according to an accelerator operation while traveling. When the engine 1 is used as a power source, a torque of the engine 1 is transmitted to the tires 5a and 5b via a clutch mechanism (not shown) and the differential gear 4. When the motor 3 is used as a power source, a direct-current electricity of the battery 9 is converted into an alternating-current electricity through the DC link 7 and the inverter 8, and the motor 3 is driven by the alternating-current electricity. Thus, a torque of the motor 3 is transmitted to the tires 5a and 5b via the differential gear 4. The vehicle travels only with the engine 1 as a power source in an engine traveling mode. The vehicle travels only with the motor 3 as a power source in a motor traveling mode. The vehicle travels with both the engine 1 and the motor 3 as a power source in a hybrid traveling mode. The hybrid traveling mode may include both the hybrid traveling mode and the engine traveling mode.

A torque of the engine 1 is transmitted to the generator 2. The generator 2 receives the torque and generates an alternating-current electricity. The inverter 6 and the DC link 7 convert the generated alternating-current electricity into a direct-current electricity. The battery 9 accumulates the converted direct-current electricity. The engine 1 consumes fuel and causes an electricity to charge the battery 9. The charge of the battery 9 accompanied with fuel consumption by the engine 1 in this way is internal combustion charge.

When a braking mechanism (not shown) decelerates the hybrid vehicle, a resistance at the time of the deceleration is applied as a torque to the motor 3. The motor 3 receives the torque and generates an alternating-current electricity. The inverter 8 and the DC link 7 convert the generated alternating-current electricity into a direct-current electricity. The battery 9 accumulates the converted direct-current electricity. The charge of the battery 9 accompanied with regeneration of electricity by the motor 3 in this way is regeneration charge.

The HV control unit 10 controls the above-described operation of the generator 2, the motor 3, the inverter 6, the inverter 8, the battery 9, and the like and non-operation of these components, according to an instruction from the navigation ECU 20 and/or the like. For example, the HV control unit 10 may include a microcomputer and may have an exclusive circuit structure for performing the following functions.

More specifically, the HV control unit 10 stores two values including a current SOC and a reference SOC. Furthermore, the HV control unit 10 performs the following operations (A) and (B).

(A) The HV control unit 10 repeatedly switches multiple driving modes such as the motor traveling mode and the hybrid traveling mode, which use different power sources, according to an accelerator position, a charge quantity of the battery 9, a temperature of the battery 9, and the like. In addition, the HV control unit 10 changes the reference SOC based on a control target value (target SOC) inputted from the navigation ECU 20 and controls the generator 2, the motor 3, the inverter 6, the inverter 8 and the like such that the charge quantity of the battery 9 of the hybrid vehicle coincides with the target SOC. The HV control unit 10 further repeatedly controls operation and non-operation of the internal combustion charge and controls operation and non-operation of the regeneration charge. The HV control unit 10 determines the traveling mode and controls the actuator based on the determined traveling mode so as to maintain the current SOC around the target SOC.

(B) The HV control unit 10 further periodically notifies the current SOC to the navigation ECU 20.

The SOC denotes a state of charge, which is an index indicating a remaining quantity of the battery. As the value of the SOC increases, the remaining quantity becomes high. The current SOC indicates the current value of the SOC of the battery 9. The HV control unit 10 successively detects the state of the battery 9 thereby to repeatedly update the current SOC. The reference SOC is a control target value such as 60% used for determining whether the HV control unit 10 causes power generation or power assistance. The reference SOC may be changed according to a control instruction transmitted from the navigation ECU 20.

The HV control unit 10 performs a control to switch the driving mode of the hybrid vehicle, switch operation and non-operation of the internal combustion charge, and switch operation and non-operation of the regeneration charge, based on the control target value transmitted from the navigation ECU 20. The control target value in the present embodiment is the target SOC. The HV control unit 10 determines the traveling mode and controls the actuator based on the determined traveling mode so as to maintain the current SOC around the target SOC. The control target value in the present embodiment is the target SOC. The HV control unit 10 determines the traveling mode and controls the actuator based on the determined traveling mode so as to maintain the current SOC around the target SOC.

When the control target value is not inputted from the navigation ECU 20, the HV control unit 10 autonomously performs a driving power control according to the vehicle speed, the accelerator position, and the like.

The GPS receiver 11, the direction sensor 12, and the vehicle speed sensor 13 are generally-known sensors respectively configured to specify the position of the hybrid vehicle, the traveling direction of the hybrid vehicle, and the traveling speed of the hybrid vehicle.

The Map DB storage, unit 14 is a storage medium for storing the map data. The map data includes node data corresponding to each of multiple intersections in the map data and link data corresponding to each of multiple links. Each link corresponds to a road section connecting one intersection with another intersection. One node data include an identification number of the node, position information on the node, and classification information on the node. One link data includes an identification number (link ID) of the link, position information on the link, and classification information on the link.

The position information on the link includes current position data of a shape-complementing point included in the link. The position information on the link further includes data of a segment, which connects two of nodes, which corresponds to ends of the link, and a shape-complementing point. Data of each segment includes information such as a segment ID of the segment, a slope of the segment, a direction of the segment, a length of the segment, and the like.

The slope sensor 15 is configured of a gyroscope sensor for detecting change in a pitch direction of the vehicle, a yaw direction of the vehicle, and a roll direction of the vehicle. The slope of a road can be calculated from the change in the pitch direction detected by the gyroscope sensor.

The wireless receiver 16 is for receiving the VICS information transmitted from the outside via wireless communications. The VICS information may include traffic congestion information, accident information, regulation information, and the like. The traffic congestion information may include a traffic congestion section between a traffic congestion start point and a traffic congestion end point, the length of the traffic congestion section, and a time needed for passing the traffic congestion.

The display unit 17 includes a display device such as a liquid crystal display device. The display unit 17 causes the display device to indicate an image according to an image signal inputted from the navigation ECU 20.

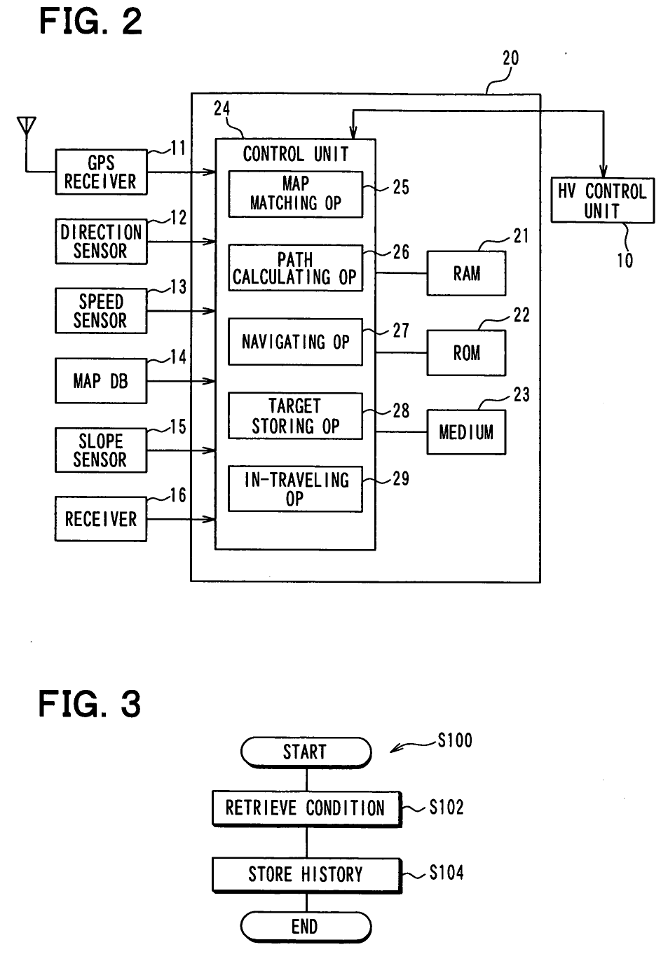

As shown in FIG. 2, the navigation ECU includes a RAM 21, a ROM 22, a durable storage medium 23 being a rewritable data medium, and a control unit 24. The durable storage medium is a storage medium configured to maintain data even when main power supply of the navigation ECU 20 stops. The durable storage medium 23 may be a hard disk, a flash memory, a non-volatile storage medium such as an EEPROM, or a backup RAM.

The control unit 24 reads a program read from the ROM 22 and/or the durable storage medium 23 and executes the program. The control unit 24 simultaneously reads information from the RAM 21, the ROM 22, and/or the durable storage medium 23. The control unit 24 further writes information on the RAM 21 and/or the durable storage medium 23. The control unit 24 further exchanges signals with the HV control unit 10, the GPS receiver 11, the direction sensor 12, the vehicle speed sensor 13, the map DB storage unit 14, the slope sensor 15 and the like. The control unit 24 performs a current position specifying operation to specify the current position based on information obtained from the GPS receiver 11, the direction sensor 12, and the vehicle speed sensor 13 for specifying the current position.

As shown in FIG. 2, the control unit 24 executes a program to perform a map matching operation 25, a path calculating operation 26, a navigating operation 27, a control target value storing operation 28, an in-traveling operation 29, and the like.

The control unit 24 performs the map matching operation 25 to specify a road including, the current position in the map of the map DB storage unit 14, based on information obtained from the GPS receiver 11, the direction sensor 12, and the vehicle speed sensor 13 for specifying the current position.

The control unit 24 performs the path calculating operation 26 to determine an optimal path to a destination, which is specified by a user using an operation apparatus (not shown), from the map data.

The control unit 24 performs the navigating operation 27 to cause the display unit 17, a speaker (not shown), and the like to indicate a guide indication to a driver so as to facilitate traveling of the hybrid vehicle along the running path to the destination.

The control unit 24 performs a traveling condition storing operation for retrieving traveling conditions, which are for specifying a schedule of a control index during traveling of the vehicle, and for storing the retrieved driving conditions in the durable storage medium 23.

The control unit 24 performs the control target value storing operation 28 to specify a scheduled section in advance of a traffic congestion start point by a specific distance and connected to the traffic congestion start point. The control unit 24 further specifies a schedule of the target SOC in the scheduled section on assumption that the vehicle travels through the scheduled section in the same condition as the traveling condition stored in the durable storage medium 23. The control unit 24 further stores the schedule of the target SOC in the durable storage medium 23.

In the in-traveling operation 29, the control unit 24 further determines whether a schedule of the target SOC corresponding to the current position of the vehicle is stored in the durable storage medium 23. When making a positive determination, the control unit 24 performs a driving power control of the engine and the motor according to the schedule of the target SOC stored in the durable storage medium 23.

FIG. 3 is a flow chart showing the traveling condition storing operation. When an ignition switch device of the vehicle is activated (turned ON), the present driving power control apparatus is turned to be in an operating state. Thus, the control unit 24 periodically performs the operation shown in FIG. 3.

First, at S102, the control unit 24 retrieves a traveling condition. In the present embodiment, the control unit 24 retrieves a traveling condition at an interval of a specific distance such as 5 (m). The traveling condition may include a vehicle speed (km/h), a road slope (%), a driving power (W) of the motor 3, a traveling time (second) in the section, a stop rate (%) in the section, a power consumption (W) consumed by auxiliary apparatuses such as an airconditioner, the navigation device, and the like. The stop rate in the section is calculated by dividing the stopping time in the section by the traveling time in the section (stop rate=stopping time/traveling time).

Subsequently, at S104, the control unit 24 stores a traveling history. Specifically, the control unit 24 specifies a road identifier of the road, in which the self-vehicle is located, and associates the specified road identifier with the traveling condition (traveling history) retrieved at S102. The control unit 24 further stores the associated road identifier in the durable storage medium 23. In the present embodiment, the traveling condition corresponding to the travel distance more than 10 (km) can be stored.

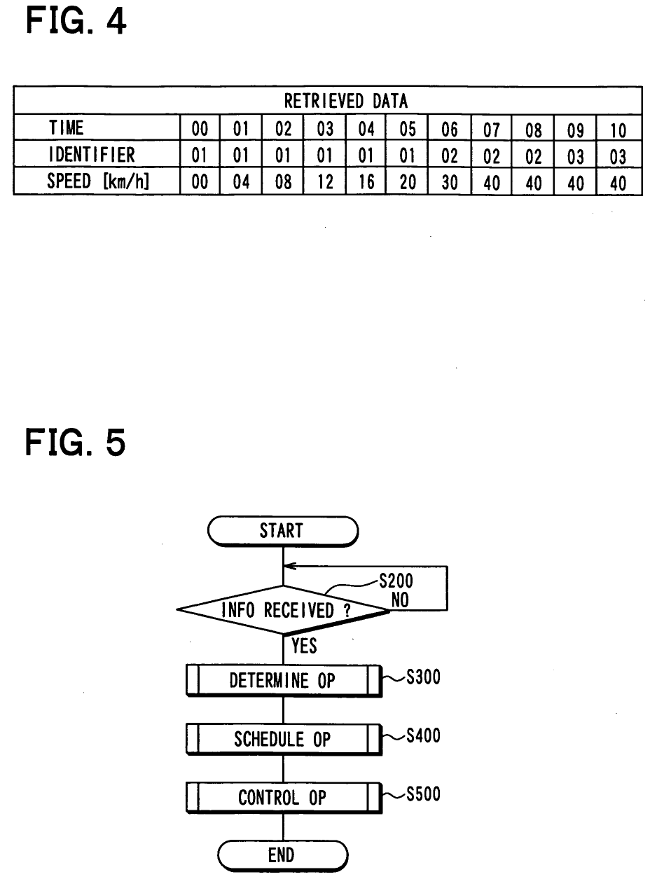

FIG. 4 is a view showing one example of the traveling condition stored in the durable storage medium 23. FIG. 4 shows only the vehicle speed. In this manner, the control unit 24 associates the traveling condition retrieved at a specific time interval with the road identifier, and stores the associated traveling condition in the durable storage medium 23. The road identifier is the link ID or the segment ID for identifying the road section.

In the traveling condition storing operation, when the vehicle travels on a highway, a traveling condition corresponding to traveling on a highway is stored in the durable storage medium 23. Alternatively, when the vehicle travels on a local road, a traveling condition corresponding to traveling on a local road is stored in the durable storage medium 23. When the vehicle traveling on a local road starts traveling on a highway, a traveling condition corresponding to traveling from a local road to a highway is stored in the durable storage medium 23.

FIG. 5 is a flow chart showing a control target value control operation 28. When the ignition switch device of the vehicle is activated (turned ON), the control unit 24 periodically performs the operation shown in FIG. 5 simultaneously with the operation shown in FIG. 3.

First, at S200, the wireless receiver 16 receives external information. The control unit 24 determines whether a traffic congestion section exists ahead in a traveling direction based on the received external information.

When the wireless receiver 16 does not receive external information or when the control unit 24 determines that a traffic congestion section does not exist ahead in the traveling direction based on the received external information, S200 makes a negative determination. In this case, the control unit 24 repeats the determination at S200.

Alternatively, when the wireless receiver 16 receives external information and when the control unit 24 determines that a traffic congestion section exists ahead in the traveling direction based on the received external information, S200 makes a positive determination. In this case, the processing proceeds to S300 at which the control unit 24 performs a schedule effect determining operation subsequently.

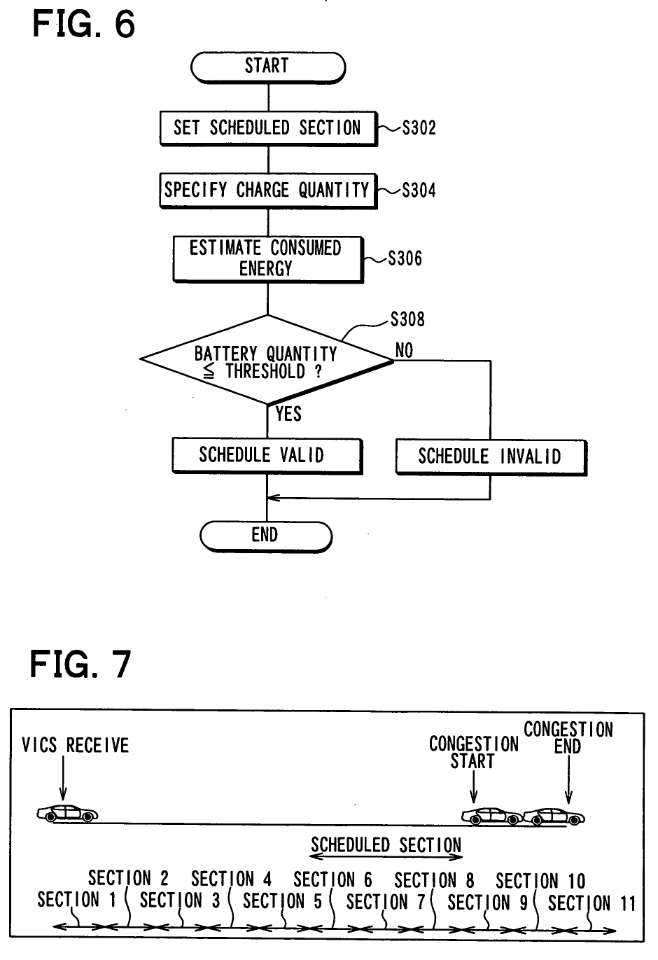

FIG. 6 is a flow chart showing the schedule effect determining operation. In the schedule effect determining operation, at S302, a scheduled section is first specified. Specifically, the control unit 24 extracts a partial section in advance of a traffic congestion section, as a scheduled section. In the present embodiment, the control unit 24 extracts a partial section, which extends from a specific point in advance of a traffic congestion start point and connecting with the traffic congestion start point to the traffic congestion start point, as a scheduled section.

FIG. 7 is a view showing an example of extraction of a scheduled section. In the example of FIG. 7, sections 9 and 10 are traffic congestion sections, and the sections 6 to 9 in advance of the traffic congestion start point of the traffic congestion sections 9 and 10 are extracted as scheduled sections.

In the present embodiment, a path to a destination is not searched. Therefore, when the road ahead in the traveling direction branches, it is unknown which way the vehicle goes to. Therefore, when traffic congestion sections exist in roads ahead of a branch, sections in advance of the traffic congestion sections ahead of the branch are extracted. For example, it is supposed that the vehicle is traveling on a highway. In this case, when one traffic congestion section exists ahead in the traveling direction, and when another traffic congestion section exists ahead of the one traffic congestion section, sections in advance of all the traffic congestion sections are extracted.

Subsequently, at S304, the current remaining capacity of the battery is specified. The navigation ECU 20 is configured to input a signal indicating the remaining quantity (battery charge quantity) of the battery 9 for driving the motor 3. The remaining quantity of the battery is specified by using the signal indicating the current remaining battery capacity.

Subsequently, at S306, a consumed energy in the traffic congestion section is estimated. Specifically, a consumed electric power (required electric power) needed for driving the motor 3 by using the battery 9 when performing an EV traveling in the traffic congestion section by only using the motor 3 is calculated. In general, it is preferable to travel a vehicle by using only a motor to reduce fuel consumption in such as a traffic congestion section in which a driving efficiency of an engine is low. Accordingly, it is presently supposed to perform EV traveling by only using the motor 3 in the traffic congestion section. It is supposed that an auxiliary apparatus such as an airconditioner and a navigation device consumes an energy of A (kW) per unit time, and the vehicle needs a time of B seconds to pass through the traffic congestion section. It is further supposed that the auxiliary apparatus consumes an energy of C (kW) when the vehicle passes through the traffic congestion section, and the vehicle consumes energy of D (kW) when performing EV traveling to pass through the traffic congestion section. On such a supposition, energy E needed for the vehicle in an EV driving mode to travel through the traffic congestion section is calculated by: E=A×B+D=C+D. The energy D (kW) needed when the vehicle performs EV traveling through a traffic congestion section can be obtained from a traveling model, which specifies a traveling pattern in the traffic congestion section.

For example, it is supposed that an average vehicle speed in the traffic congestion section is 10 (km/h) (2.7 m/s). In this case, for example, a 40-second model is used for calculating the energy D needed when the vehicle performs EV traveling through the traffic congestion section. The 40-second model, for example, specifies that the vehicle accelerates from 0 (km/h) to 20 (km/h) within 7 seconds, constantly travels for 15 seconds, decelerates to 0 (km/h) within 7 seconds, and stops for 11 seconds. It is further supposed that the length of the traffic congestion section is 10 km. In this case, the energy D is calculated by D=(energy consumed in 40-second traveling)×10 (km)/2.7 (m/s)/40 (second).

Alternatively, when it is supposed that the length of the traffic congestion section is 5 km, the energy D needed when the vehicle performs EV traveling through the traffic congestion section is calculated by D=(energy consumed in 40-second traveling)×5 (km)/2.7 (m/s)/40 (second). The energy consumed in the 40-second traveling is a predetermined value specific to each vehicle and stored in the durable storage medium 23. In the present embodiment, a traveling model is prepared for each average vehicle speed obtained from the VICS information in this way, and the energy D is calculated in the same way.

The energy D needed for EV traveling through the traffic congestion section changes in dependence upon the slope of the traffic congestion section. Therefore, in the present embodiment, the slope in the traffic congestion section specified by the traffic congestion information is obtained, and the energy D needed for EV traveling through the traffic congestion section is corrected based on the slope of the traffic congestion section, in order to enhance an accuracy of the calculated energy D. The slope of the traffic congestion section may be specified with, reference to the map data or may be specified with reference to data, which is obtained through traveling of the self-vehicle. In the present embodiment, the energy D is multiplied by a coefficient K, which is specified according to the slope, thereby to correct the energy D. The energy D is corrected with the coefficient K<1 in an uphill slope, the coefficient K=1 in a flat section, and the coefficient K>1 in a downhill slope.

Subsequently, at S308, it is determined whether the remaining battery capacity becomes below a threshold in the traffic congestion section. Specifically, a consumed electric power needed for the battery 9 for driving the motor 3 when the vehicle travels the traffic congestion section using the motor 3 is calculated. Subsequently, based on the calculated consumed electric power, a required battery charge quantity needed at the traffic congestion start point is calculated. The required battery charge quantity is calculated such that the charge quantity of the battery at the traffic congestion end point after the vehicle travels the traffic congestion section using the motor 3 is equal to or greater than a predetermined minimum reference value. In the present embodiment, the minimum reference value of the battery charge quantity is specified to a battery charge quantity, which causes operation of the engine to generate an electricity when the vehicle stops.

When the required battery charge quantity is equal to or greater than the current remaining battery capacity specified at S304, it is necessary to charge the battery 9 before arriving at the traffic congestion start point at least. In the present embodiment, the required battery charge quantity is compared with the current remaining battery capacity specified at S304 to determine whether the remaining battery capacity becomes equal to or less than the threshold in the traffic congestion section.

When it is determined that the remaining battery capacity becomes equal to or less than the threshold in the traffic congestion section, S308 makes a positive determination (schedule valid determination). Alternatively, when the remaining battery capacity becomes greater than the threshold in the traffic congestion section, S308 makes a negative determination (schedule invalid determination).

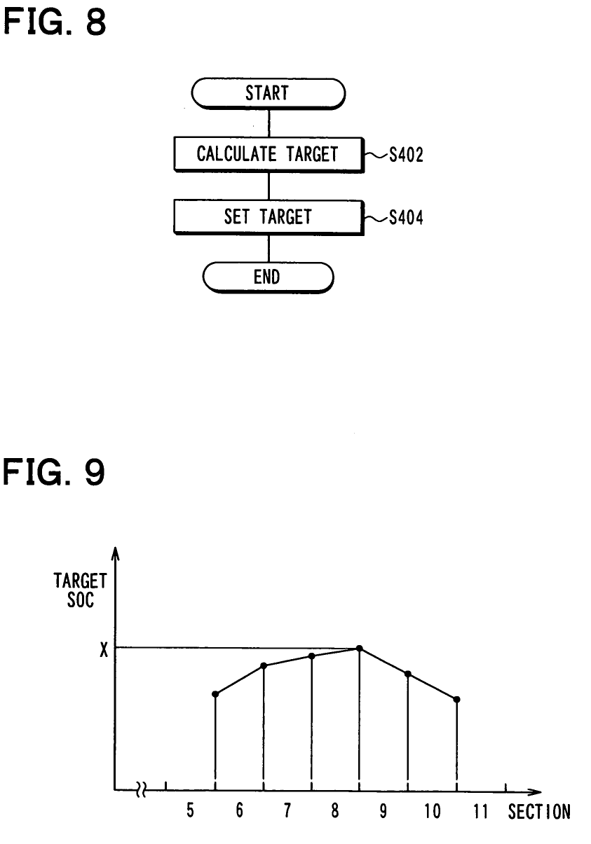

As follows, a scheduling operation at S400 in FIG. 5 will be subsequently described. FIG. 8 is a flow chart showing the scheduling operation. The scheduling operation is performed when S308 makes the schedule valid determination. Alternatively, the scheduling operation is not performed when S308 makes the schedule invalid determination. That is, the processings shown in FIG. 5 is terminated when S308 makes the schedule invalid determination.

In the scheduling operation, at S402, a control target value is first calculated so as to secure electricity generation required in a road in advance of the traffic congestion section. Specifically, similarly to S306, 308, a consumed electric power needed for the battery 9 for driving the motor 3 when the vehicle travels the traffic congestion section using the motor 3 is calculated. Subsequently, based on the calculated consumed electric power, a required battery charge quantity needed at the traffic congestion start point is calculated. The required battery charge quantity is calculated such that the charge quantity of the battery at the traffic congestion end point after the vehicle travels the traffic congestion section using the motor 3 is equal to or greater than a predetermined minimum quantity.

Subsequently, at S404, the control target value is set for each road section. Specifically, a partial section in advance of a traffic congestion section is extracted as a scheduled section. Subsequently, in the extracted scheduled section, a schedule of a control index is specified for each predetermined section such that the charge quantity of the battery 9 at the traffic congestion start point is equal to or greater than the required battery charge quantity. The presently extracted section needs to have a sufficient length such that the charge quantity of the battery 9 at the traffic congestion start point is equal to or greater than the required battery charge quantity. In the traveling condition storing operation shown in FIG. 3, a latest traveling condition for a specific distance such as 2000 m is obtained from the traveling condition stored in the durable storage medium 23. Subsequently, using the obtained traveling condition, an SOC control schedule in the scheduled section is generated. The SOC control schedule is an expectation of transition of the target SOC (control target value) to the destination. The expectation of transition of the target SOC is described in Publication of Japanese Patent Application 2001-183150 and “Development of an alternative energy automobile” (CMC publication) pages 123 to 124, and the like. Thus, detailed description of the expectation of transition of the target SOC is omitted.

FIG. 9 is a graph showing one example of expectation of transition of the target SOC. As shown in FIG. 9, in the present embodiment, a SOC control schedule is generated by associating a road identifier in each scheduled section with each specified target SOC.

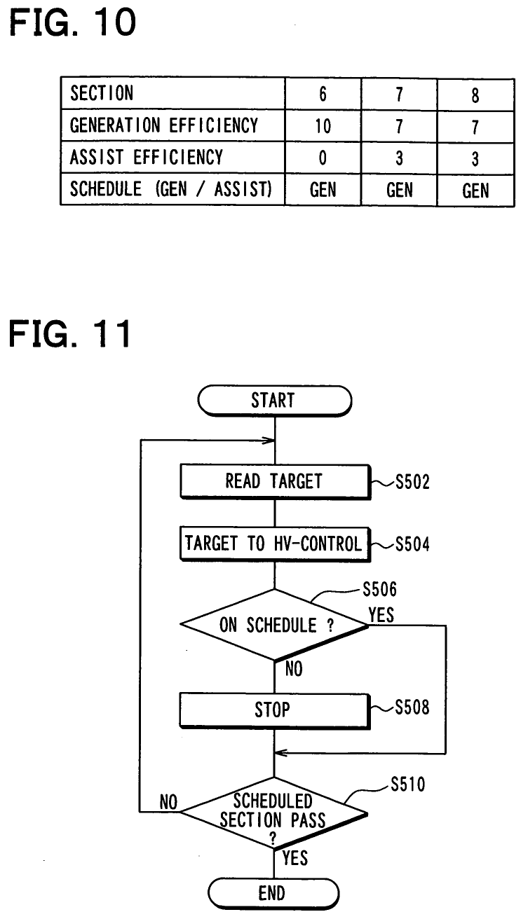

FIG. 10 shows one example of the SOC control schedule generated correspondingly to the scheduled sections shown in FIG. 7. As shown in FIG. 10, a power generation efficiency and an assist efficiency are calculated for each scheduled section. Thus, a control mode including regeneration charge, power generation, and assist is determined for each road section. The schedule is generated to charge the battery 9 at the scheduled sections 6 to 8 such that the charge quantity of the battery 9 at the traffic congestion start point is equal to or greater than the required battery charge quantity, and the control target value (target SOC) X is obtained at the traffic congestion start point. In this manner, the SOC control schedule is generated only in the partial section (scheduled section) immediately in advance of the traffic congestion section. Therefore, in this manner, the battery can be restricted from being completely charged at a distant point in advance of the traffic congestion section, for example. Thus, the vehicle can be traveled with low fuel consumption.

As follows, a schedule control operation at S500 in FIG. 5 will be subsequently described. FIG. 11 is a flow chart showing the schedule control operation. In the schedule control operation, at S502, a control target value corresponding to a traveling position is first read. Specifically, the road section, in which the vehicle is located, is specified based on the current position of the vehicle specified in the current position specifying operation and the map data stored in the map DB storage unit 14. Further, a control target value corresponding to the specified road section, in which the vehicle is located, is read from the durable storage medium 23. When the control target value corresponding to the specified road section is not stored in the durable storage medium 23 (not shown), the processing proceeds to S510.

When the control target value corresponding to the specified road section is stored in the durable storage medium 23, the processing proceeds to S504. At S504, the control target value corresponding to the current position of the vehicle is transmitted to the HV control unit. When the vehicle is located in the scheduled section, the control target value corresponding to the current position of the vehicle is transmitted to the HV control unit. Alternatively, when the vehicle is not located in the scheduled section, transmission of the control target value is interrupted. In this case, the HV control unit 10 performs a driving power control to control the charge quantity of the battery 9 at the control target value.

At S506, it is determined whether the charge quantity of the battery 9 changes as scheduled based on whether the current SOC approaches the control target value.

When the current SOC approaches the control target value, S506 makes a positive determination. In this case, at S510, it is determined whether the vehicle has passed through the scheduled section based on whether the vehicle has reached the traffic congestion end point.

When the vehicle has not reached the traffic congestion end point, S510 makes a negative determination, and the processing returns to S502. When the current SOC does not change to approach the control target value, S506 makes a negative determination. In this case, at S508, the driving power control is terminated even when the vehicle has not reached a predetermined range specified on the basis of the destination. Specifically, transmission of the control target value is terminated. In this case, the HV control unit 10 performs a driving power control to control the charge quantity of the battery 9 at the control target value.

When the vehicle reaches the traffic congestion end point, S510 makes a positive determination, and the present processing is terminated. In this manner, the navigation ECU 20 does not transmit the control target value to the HV control unit 10. Thus, a driving power control is performed according to the vehicle speed, the accelerator position, and the like.

According to the above-described structure, when it is determined that a traffic congestion section exists ahead of the current position in the traveling direction based on wireless information, the required battery charge quantity needed at the traffic congestion start point is specified such that the charge quantity of the battery, which is for driving the motor, at the traffic congestion end point is more than the predetermined reference value after traveling through the traffic congestion section using the motor. In addition, the partial section in advance of the traffic congestion start point is extracted, and the schedule of the control index in the partial section in advance of the traffic congestion start point is specified such that the charge quantity of the battery at the traffic congestion start point is more than the required battery charge quantity. Therefore, an operation for specifying the path to the destination is not needed, and reduction in energy consumption can be promoted.

Furthermore, on assumption that the vehicle travels in the same condition as the traveling condition retrieved in the partial section in advance of the current position of the vehicle, the schedule of the control index is specified for the partial section in advance of the traffic congestion start point. That is, the schedule of the control index can be specified to conform with the actual traveling condition of the vehicle.

Furthermore, the slope in the traffic congestion section is specified. In addition, the consumed electric power needed for the battery, which is for driving the motor, when the vehicle travels the traffic congestion section using the motor is corrected based on the specified slope in the traffic congestion section. Therefore, consumed electric power can be specified with sufficient accuracy.

Furthermore, when it is determined that multiple traffic congestion sections exist ahead of the current position in the traveling direction based on the wireless information, the required battery charge quantity needed at the traffic congestion start point is specified for each of the traffic congestion sections. In addition, the partial section in advance of the traffic congestion start point is extracted for each of the multiple traffic congestion sections. Further, the schedule of the control index is specified for the partial section in advance of each of the traffic congestion start points. For example, it is supposed that the road branches ahead of the current position in the traveling direction, and the traffic congestion section exist in each of the roads ahead of the branch. In such a condition, irrespective of the road to which the vehicle moves beyond of the branch, the driving power control can be adequately performed according to the schedule of the control index.

### Second Embodiment

In the first embodiment, the energy D needed for EV traveling through a traffic congestion section is determined by using the traveling model, which specifies the traveling pattern in the traffic congestion section. In the present second embodiment, an axle torque, an axle rotation speed, and a brake braking torque when the vehicle travels through a traffic congestion section are specified beforehand. Further, an energy D needed for EV traveling through a traffic congestion section is specified using such information of the axle torque, the axle rotation speed, and the brake braking torque.

The energy D can be calculated by: energy D=traveling energy+power consumption of auxiliary apparatus−regeneration energy. The traveling energy=Σ(axle torque [Nm]×axle rotation speed [rpm]×2π/60/1 000). The regeneration energy=Σ(brake braking torque [Nm]×axle rotation speed [rpm]×−2π/60/1000). The power consumption of auxiliary apparatus=Σ(power consumption of auxiliary apparatus). It is noted that regeneration energy regenerative per unit time has a limit. Therefore, when regeneration energy in the formula exceeds a predetermined upper limit thereof, the maximum value of regeneration energy may be used as the regeneration energy.

### Third Embodiment

In the first embodiment, at S306, the energy D needed for EV traveling through a traffic congestion section is determined by using the traveling model, which specifies the traveling pattern in the traffic congestion section. In the present third embodiment, a traffic congestion section power consumption specifying operation is performed to specify a traveling model of the traffic congestion section based on a traveling history retrieved (collected) while the vehicle travels. Further, the energy D needed for EV traveling through a traffic congestion section is determined using the specified traveling model.

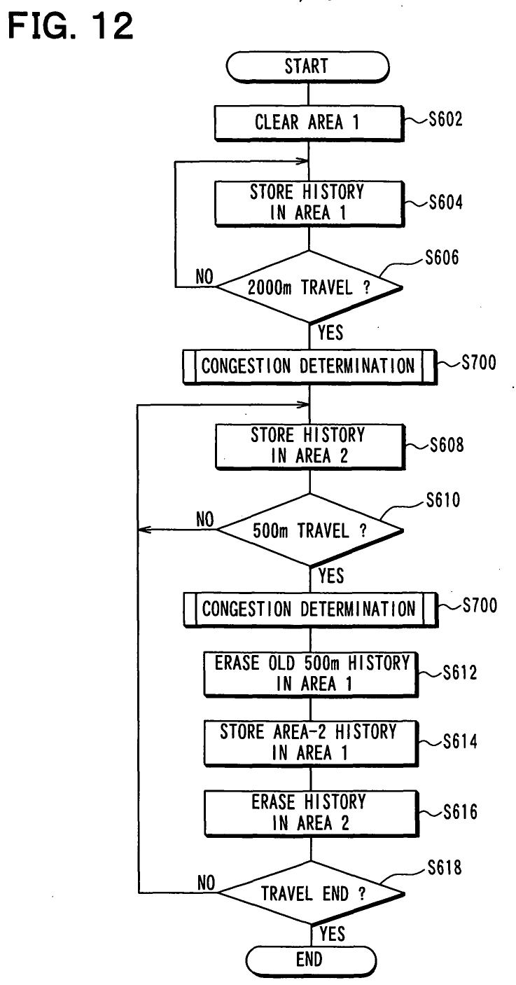

FIG. 12 is a flow chart showing the traffic congestion section power consumption specifying operation according to the embodiment. When an ignition switch device of the vehicle is activated (turned ON), the control unit 24 periodically performs the operation shown in FIG. 12.

In the present operation, at S602, data stored in the first storage area 1S of the RAM 21 is first erased. At S604, the first storage area 1S of the RAM 21 is caused to store a traveling history retrieved in a road section at a specific time interval such as 0.5 second. In the present embodiment, a traveling history such as the vehicle speed and the driving force is stored such that a traveling history in a stopping time of the vehicle is reduced. The traveling history may include the vehicle speed (km/h), the driving power (W) of the motor 3, the traveling time in the section (second), the stopping time in the section (second), the average vehicle speed (km/h) in the section, the stop rate in the section (%), and the like. average vehicle speed=Σ(vehicle speed/traveling time) The stop rate in the section is calculated by dividing the stopping time in the section by the traveling time in the section (stop rate=stopping time/traveling time).

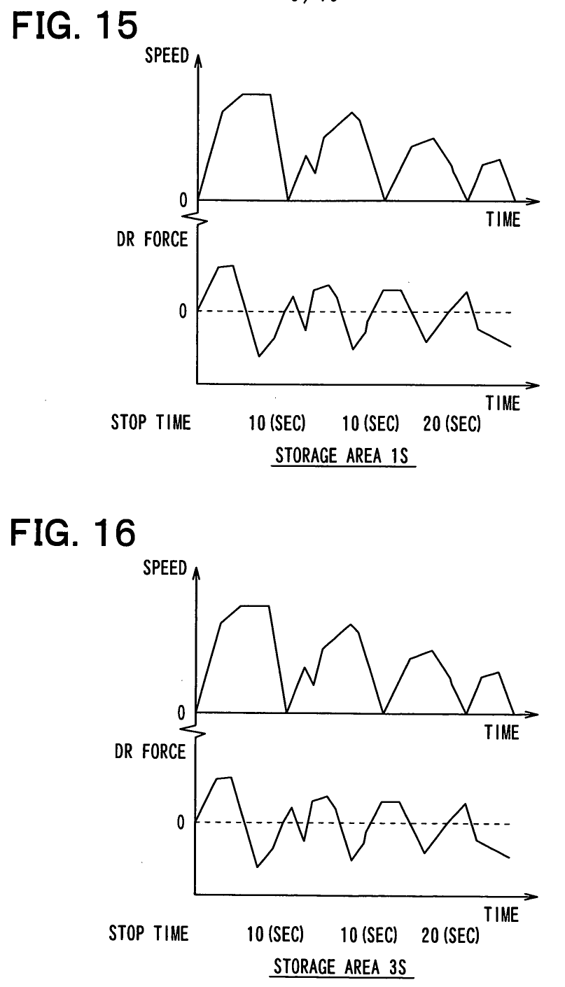

FIG. 14 is a view showing one example of a retrieved traveling history such as the vehicle speed and the driving force. FIG. 15 is a view showing one example of a retrieved traveling history such as the vehicle speed and the driving force stored in the first storage area 1S. As shown in FIG. 15, a traveling history is stored in the first storage area 1S while a part of the traveling history when the vehicle is stopping (vehicle speed=0) is deleted. The stopping time is stored in the first storage area 1S separately from the traveling history.

Subsequently, at S606, it is determined whether the vehicle has traveled for a specific distance. In the present embodiment, it is determined whether the travel distance of the vehicle has reached 2000 (m).

When the travel distance of the vehicle has not reached 2000 (m), S606 makes a negative determination. In this case, the processing repeats the determination of S606. When it is determined that the travel distance of the vehicle has reached 2000 (m), S606 makes a positive determination. In this case, a traffic congestion section determining operation will be subsequently performed.

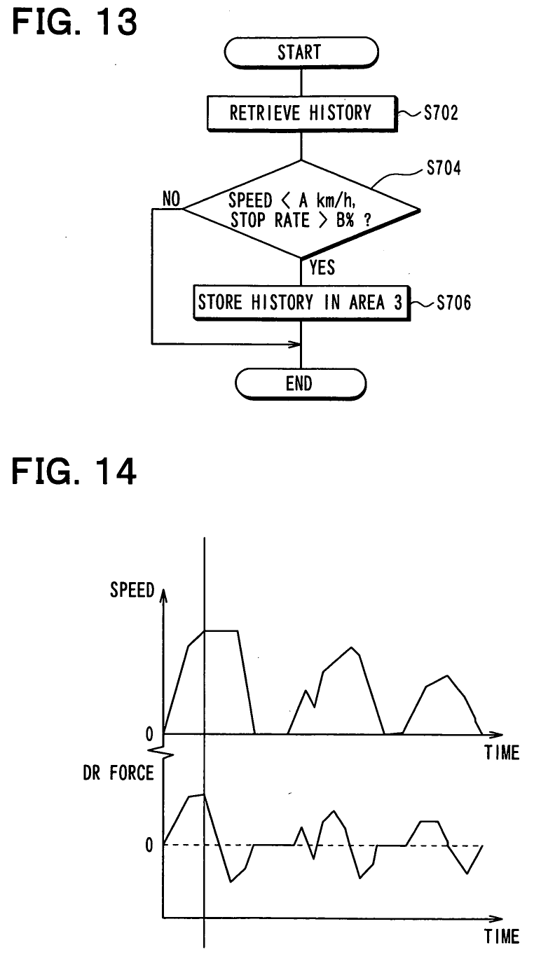

FIG. 13 is a flow chart showing the traffic congestion section determining operation. In the traffic congestion section determining operation, at S702, a stored traveling history is first obtained. Specifically, a traveling history stored in the first storage area 1S is obtained at this time.

Subsequently, at S704, it is determined whether the current position is in a traffic congestion section based on a determination whether a traffic congestion condition is satisfied. The traffic congestion condition is specified by, for example, “whether the average vehicle speed is less than A (km/h), and whether the stop rate is greater than B (%).”

When the average vehicle speed is less than A (km/h) and when the stop rate is greater than B (%), S704 makes a positive determination. In this case, at S706, the third storage area 3S is caused to store the traveling history obtained at S702, i.e., the traveling history stored in the first storage area 1S, as a traveling history of the traffic congestion section.

FIG. 16 is a view showing one example of a retrieved traveling history such as the vehicle speed and the driving force stored in the third storage area 3S. In the present example, a latest traveling history of 2000 (m) when the traffic congestion conditions is satisfied is stored in the third storage area 3S.

At S608 in FIG. 12, the second storage area 2S of the RAM 21 is caused to store a traveling history retrieved in the road section at a specific time interval such as 0.5 second.

Subsequently, at S610, it is determined whether the vehicle has traveled for a specific distance. In the present embodiment, it is determined whether the travel distance of the vehicle has reached 500 (m).

When it is determined that the travel distance of the vehicle has not reached 500 (m), S606 makes a negative determination, and the processing returns to S608.

FIG. 17 is a view showing one example of a retrieved traveling history such as the vehicle speed and the driving force stored in the second storage area 2S. The second storage area 2S stores the traveling history of 500 (m), which is retrieved after traveling of 2000 (m) or more. Similarly to the first storage area 1S, the second storage area 2S stores the traveling history such as the vehicle speed and the driving force after a part of the traveling history in the stopping time is deleted. The stopping time is stored separately from the traveling history such as the vehicle speed and the driving force.

When it is determined that the travel distance of the vehicle has reached 500 (m), S610 makes a positive determination. In this case, a traffic congestion section determining operation will be again performed.

Specifically, at S702 of the traffic congestion section determining operation, the traveling history stored in the second storage area 2S is obtained. Therefore, at S706, the third storage area 3S is caused to store the traveling history, which is stored in the second storage area 2S, as a traveling history in the traffic congestion section.

At S612 in FIG. 12, the oldest portion of the traveling history of 500 (m) stored in the first storage area 1S is erased. That is, the oldest portion of 500 (m) among the entire traveling history stored in the first storage area 1S is erased.

Subsequently, at S614, the first storage area 1S is caused to store the traveling history in the second storage area 2S. Specifically, the first storage area 1S is caused to store the latest portion of the traveling history of 500 (m) stored in the second storage area 2S. Further, the traveling history between 500 (m) and 2000 (m) stored in the first storage area 1S is integrated.

Subsequently, at S616, the traveling history in the second storage area 2S is erased. Specifically, the traveling history stored in the second storage area 2S is erased.

Subsequently, at S618, it is determined whether the vehicle has terminated traveling. In present embodiment, it is determined whether the vehicle has terminated traveling based on whether the shift lever is positioned at the parking position (P position).

When the shift lever is out of the parking position (P position), S618 makes a negative determination, and the processing returns to S608. In this way, every time the vehicle travels for 500 (m), the latest traveling history of 2000 (m) is stored in the first storage area 1S.

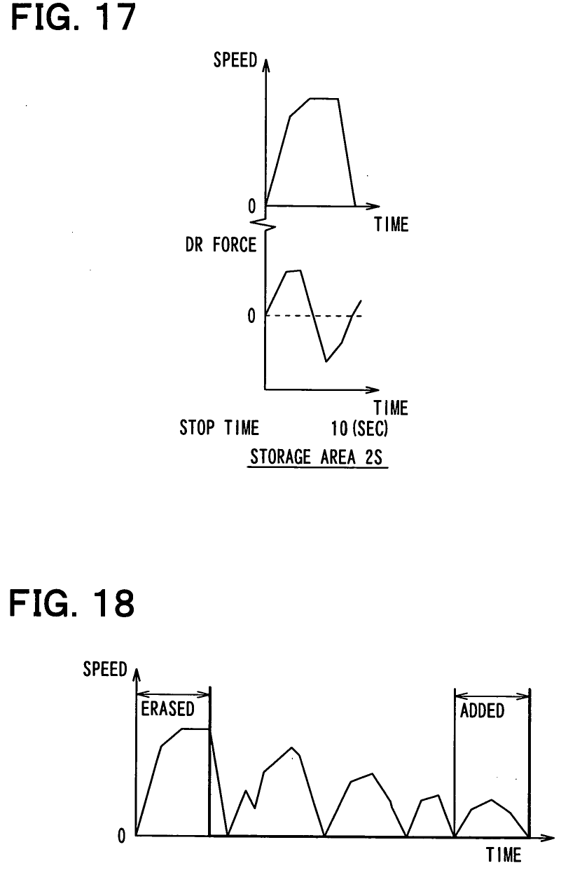

FIG. 18 is a view showing one example of a retrieved traveling history such as the vehicle speed and the driving force stored in the first storage area 1S. As shown in FIG. 18, the latest traveling history of 500 (m) is stored in the first storage area 1S, and the oldest traveling history of 500 (m) in the first storage area 1S is erased. In this way, every time the vehicle travels for 500 (m), the traveling history of 2000 (m) stored in the first storage area 15 is updated.

When the shift lever is positioned at the parking position (P position), S618 makes a positive determination. Thus, the present processing is terminated.

In the traffic congestion section power consumption specifying operation, the third storage area 3S is caused to store the traveling history such as the vehicle speed and the driving force when the vehicle is traveling through the traffic congestion section. Further, a traveling model of a traffic congestion section is specified based on the traveling history retrieved while the vehicle travels through the traffic congestion section. In addition, a consumed electric power, which is needed for the battery 9 to drive the motor 3 to perform EV traveling through the traffic congestion section, is calculated using the traveling model of the traffic congestion section. The control unit 24 specifies the axle rotation speed based on the vehicle speed. The control unit 24 further specifies the axle torque and the brake braking torque based on the driving force. Thereby, the energy D, which is needed for EV traveling in the traffic congestion section, can be calculated, similarly to the second embodiment.

As described above, when it is determined whether the vehicle is traveling in a traffic congestion section, the consumed electric power, which is needed for the battery to drive the motor so as to travel the vehicle through the traffic congestion section, can be calculated by using the traveling history retrieved while the vehicle travels through the traffic congestion section.

### Other Embodiments

In the above first to third embodiments, the vehicle driving power control apparatus is applied to a hybrid vehicle, which uses both an engine and a motor as a power source for traveling, as an example. It is noted that, the vehicle driving power control apparatus may be applied to, for example, a plug-in hybrid vehicle adapted to be charged by using a home power supply equipment or the like. Alternatively, the vehicle driving power control apparatus may be applied to a vehicle provided with an internal combustion engine for charging a battery, which is for driving a motor.

In the above first to third embodiments, the schedule effect determining operation 300 shown in FIG. 5 is performed. In addition, when it is determined that the schedule effect is effective in the schedule effect determining operation 300, the scheduling operation S400 is performed. It is noted that the schedule effect determining operation 300 may be omitted. In this case, the scheduling operation S300 may be regularly performed.

In the first embodiment, at S308, the minimum reference value of the battery charge quantity is specified to drive the engine to start power generation when the vehicle is stopping. It is noted that, for example, the minimum reference value of the battery charge quantity may be specified to start power generation even in an inefficient speed range (inefficient acceleration range) in which power generation is not normally performed.

The wireless receiver 16 may be equivalent to a receiving unit. Step S402 may be equivalent to a required battery charge quantity specifying unit (required charge specifying unit). Step S404 may be equivalent to a schedule specifying unit. The traveling condition storing operation of FIG. 3 may be equivalent to a traveling condition storing operation unit (condition storing unit). Step S704 may be equivalent to a in-traffic congestion section traveling determination unit.

Summarizing the above embodiments, a vehicle driving power control apparatus includes:

a receiving unit configured to receive wireless information;

a required battery charge quantity specifying unit configured to, when determining that a traffic congestion section (congestion) exists ahead of a current position in a traveling direction based on the wireless information received by the receiving unit, specify a required battery charge quantity needed at a traffic congestion start point (congestion start), such that a charge quantity of a battery, which is for driving a motor, is more than a predetermined reference value at a traffic congestion end point (congestion end) when traveling through the traffic congestion section using the motor; and

a schedule specifying unit configured to: i) extract a partial section in advance of the traffic congestion start point; and ii) specify a schedule of a control index in the partial section in advance of the traffic congestion start point, such that the charge quantity of the battery at the traffic congestion start point is more than the required battery charge quantity.

According to the present structure, when it is determined that the traffic congestion section exists ahead of the current position in the traveling direction based on the wireless information, the required battery charge quantity needed at the traffic congestion start point is specified such that the charge quantity of the battery, which is for driving the motor, at the traffic congestion end point is more than the predetermined reference value after traveling through the traffic congestion section using the motor. In addition, the partial section in advance of the traffic congestion start point is extracted, and the schedule of the control index in the partial section in advance of the traffic congestion start point is specified such that the charge quantity of the battery at the traffic congestion start point is more than the required battery charge quantity. Therefore, an operation for specifying the path to the destination is not needed, and reduction in energy consumption can be promoted.

The vehicle driving power control apparatus further includes a traveling condition storing operation unit configured to: i) retrieve a traveling condition for specifying the schedule of the control index; and ii) cause a storing unit to store the retrieved traveling condition. The schedule specifying unit is further configured to: i) read a retrieved traveling condition of a specific section in advance of the position of the vehicle from the storing unit; and ii) specify a schedule of a control index in a partial section in advance of the traffic congestion start point on assumption to travel in the same conditions as the traveling condition.

According to the present structure, on assumption that the vehicle travels in the same condition as the traveling condition retrieved in the partial section in advance of the current position of the vehicle, the schedule of the control index is specified for the partial section in advance of the traffic congestion start point. That is, the schedule of the control index can be specified to conform with the actual traveling condition of the vehicle.

The vehicle driving power control apparatus further includes a consumed electric power arithmetic unit (power arithmetic unit) configured to calculate a consumed electric power needed for the battery to drive the motor when traveling through the traffic congestion section using the motor, based on the traffic congestion information. The required battery charge quantity specifying unit is further configured to specify the required battery charge quantity needed at the traffic congestion start point, based on the consumed electric power, such that the charge quantity of the battery is more than a predetermined reference value at the traffic congestion end point when traveling through the traffic congestion section using the motor.

In this way, a consumed electric power needed for the battery for driving the motor when traveling through the traffic congestion section using the motor is calculated based on the traffic congestion information. Subsequently, based on the calculated consumed electric power, a required battery charge quantity needed at the traffic congestion start point can be specified such that the charge quantity of the battery at the traffic congestion end point after traveling through the traffic congestion section using the motor is equal to or greater than the predetermined reference value.

The consumed electric power arithmetic unit may calculate the consumed electric power needed for the battery to drive the motor when traveling through the traffic congestion section using the motor, by using a traveling model, which specifies a traveling pattern in the traffic congestion section.

The consumed electric, power arithmetic unit is further configured to: i) specify a slope in the traffic congestion section indicated by the traffic congestion information; and ii) correct the consumed electric power needed for the battery to drive the motor when traveling through the traffic congestion section using the motor, based on the slope in the traffic congestion section.

According to the present structure, the consumed electric power needed for the battery, which is for driving the motor, when the vehicle travels the traffic congestion section using the motor is corrected based on the specified slope in the traffic congestion section. Therefore, consumed electric power can be specified with sufficient accuracy.

The vehicle driving power control apparatus further includes an in-traffic congestion section traveling determination unit configured to determine whether a self-vehicle is traveling in a traffic congestion section. When the in-traffic congestion section traveling determination unit determines that the self-vehicle is traveling in a traffic congestion section, the consumed electric power arithmetic unit may calculate a consumed electric power needed for the battery to drive the motor to travel through the traffic congestion section by using a traveling history retrieved while traveling in the traffic congestion section.

When determining that multiple traffic congestion sections exist ahead of the current position in the traveling direction based on the wireless information received by the receiving unit, the required battery charge quantity specifying unit is further configured to specify the required battery charge quantity needed at the traffic congestion start point for each of the multiple traffic congestion sections. The schedule specifying unit is further configured to: i) extract a partial section in advance of a traffic congestion start point of each of the multiple traffic congestion sections; and ii) specify a schedule of a control index for each partial section in advance of each traffic congestion start point.

According to the present structure, when it is determined that multiple traffic congestion sections exist ahead of the current position in the traveling direction based on the wireless information, the required battery charge quantity needed at the traffic congestion start point is specified for each of the traffic congestion sections. In addition, the partial section in advance of the traffic congestion start point is extracted for each of the multiple traffic congestion sections. Further, the schedule of the control index is specified for the partial section in advance of each of the traffic congestion start points. For example, it is supposed that the road branches ahead of the current position in the traveling direction, and the traffic congestion section exist in each of the roads ahead of the branch. In such a condition, irrespective of the road to which the vehicle moves beyond of the branch, the driving power control can be adequately performed according to the schedule of the control index.

The above structures of the embodiments can be combined as appropriate.

The above processings such as calculations and determinations are not limited being executed by the control unit 24 and the like. The control unit may have various structures including the control unit 24 and the like shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. A driving power control apparatus for controlling a driving power of an internal combustion engine and an electric motor of a vehicle according to a schedule of a specified control index, the driving power control apparatus comprising:
a receiving unit configured to receive wireless information;
a required charge specifying unit configured to, when determining that a congestion exists ahead based on the wireless information received by the receiving unit, specify a required charge quantity of a battery needed at a congestion start for driving the motor, such that a charge quantity of the battery remains more than a predetermined quantity at a congestion end after traveling through the congestion using the motor; and
a schedule specifying unit configured to:
extract a partial section in advance of the congestion start; and
specify a schedule of a control index in the partial section, such that the charge quantity of the battery at the congestion start is more than the required charge quantity.

2. The driving power control apparatus according to claim 1, further comprising:
a condition storing unit configured to:
retrieve a traveling condition for specifying the schedule of the control index; and
cause a storing unit to store the retrieved traveling condition, wherein
the schedule specifying unit is further configured to:
read a retrieved traveling condition of a specific section from the storing unit, the specific section being in advance of a position of the vehicle; and
specify a schedule of a control index in a partial section in advance of the congestion start on assumption to travel in the same condition as the traveling condition.

3. The driving power control apparatus according to claim 1, further comprising:
a power arithmetic unit configured to calculate a required electric power needed for the battery to drive the motor when traveling through the congestion using the motor, based on the congestion information, wherein
the required charge specifying unit is further configured to specify the required charge quantity needed at the congestion start, based on the required electric power, such that the charge quantity of the battery is more than a predetermined quantity at the congestion end when traveling through the congestion using the motor.

4. The driving power control apparatus according to claim 1, wherein the power arithmetic unit is further configured to calculate the required electric power by using a traveling model, which specifies a traveling pattern in the congestion.

5. The driving power control apparatus according to claim 1, wherein
the power arithmetic unit is further configured to:
specify a slope in the congestion from the congestion information; and
correct the required electric power based on the specified slope.

6. The driving power control apparatus according to claim 1, further comprising:
an in-congestion determination unit configured to determine whether the vehicle is traveling in a congestion, wherein
the power arithmetic unit is further configured to, when the in-congestion determination unit determines that the vehicle is traveling in a congestion, calculate the required electric power based on a traveling history retrieved while traveling in the congestion.

7. The driving power control apparatus according to claim 1, wherein
the required charge specifying unit is further configured to, when determining that a plurality of congestions exist ahead based on the wireless information received by the receiving unit, specify the required charge quantity needed at a congestion start for each of the plurality of congestions,
the schedule specifying unit is further configured to:
extract a partial section in advance of the congestion start of each of the plurality of congestions; and
specify the schedule of the control index for the extracted partial section in advance of the congestion start of each of the plurality of congestions.

8. The driving power control apparatus according to claim 1, wherein
the required charge specifying unit is further configured to, when determining that a plurality of congestions exist ahead on a single road based on the wireless information received by the receiving unit, specify the required charge quantity needed at a congestion start for each of the plurality of congestions,
the schedule specifying unit is further configured to:
extract a partial section in advance of the congestion start of each of the plurality of congestions; and
specify the schedule of the control index for the extracted partial section in advance of the congestion start of each of the plurality of congestions.

9. The driving power control apparatus according to claim 1, wherein
the required charge specifying unit is further configured to, when determining that a plurality of congestions exist ahead on a plurality of branched roads based on the wireless information received by the receiving unit, specify the required charge quantity needed at a congestion start for each of the plurality of congestions,
the schedule specifying unit is further configured to:
extract a partial section in advance of the congestion start of each of the plurality of congestions; and
specify the schedule of the control index for the extracted partial section in advance of the congestion start of each of the plurality of congestions.

10. A method for controlling a vehicle having an internal combustion engine and an electric motor, the method comprising:
receiving wireless information;
determining whether a congestion exists ahead based on the received wireless information;
specifying, when it is determined that a congestion exists ahead, a required charge quantity of a battery needed at a congestion start for driving the motor, such that a charge quantity of the battery remains more than a predetermined quantity at a congestion end after traveling through the congestion using the motor;
extracting a partial section in advance of the congestion start;
specifying a schedule of a control index in the extracted partial section, such that the charge quantity of the battery at the congestion start is more than the required charge quantity; and
manipulating a driving power of the internal combustion engine and the electric motor according to the specified schedule of the control index.
